(19) United States
(12) Patent Application Publication
(10) Pub. No.: US 2002/0085550 A1
(43) Pub. Date: Jul. 4, 2002

(54) Scalable switch

(76) Inventor: Steven Rhodes, Nepean (CA)

Correspondence Address: SMART & BIGGAR, 1000 DE LA GAUCHETIERE STREET WEST, SUITE 3400, MONTREAL, QUEBEC, H3B 4W5, CA

(21) Appl. No.: 09/749,594

(22) Filed: Dec. 28, 2000

(51) Int. Cl. H04L 12/28

(52) U.S. Cl. 370/389; 370/400

(57) ABSTRACT

A switch for establishing call sessions in a communication system including a packet network. The switch receives first packets including a source address from at least one communication link. The switch includes a shuffling unit operative to extract data from the first packets for generating second packets at least partly on a basis of the source address of the first packets, the second packets being released to the packet network. The switch also includes a switching unit for receiving third packets from the packet network, the switching unit being operative to perform switching of the third packets for establishing at least one communication session, such as a telephone call between two parties or a conference call between multiple parties. The switch is scalable to accommodate an increasing number of packets within the communication system, where these packets may be transporting data and/or voice signals.

### FIELD OF THE INVENTION

The present invention relates to a switch for use in synchronous data and/or voice systems connected to a packet network. More specifically, it pertains to a scalable switch that is able to incrementally increase its capacity as the number of connections supported by the switch increases.

### BACKGROUND OF THE INVENTION

Synchronous time division multiplex (TDM) data and/or voice systems typically include multiple timeswitches. A timeswitch is a type of switch that is commonly used to establish connections within such a system, possibly including operations such as conferencing and page broadcasting. Each timeswitch is able to connect one or several arbitrary inputs to one or several outputs, the size of a timeswitch being defined by the number of inputs and outputs supported by the timeswitch. The inputs and outputs of a timeswitch may be time division multiplexed onto one or more interfaces to the timeswitch, where these interfaces are, typically point-to-point serial physical implementations that are synchronous with the timeswitch.

The inputs may also be presented to the timeswitch through multiplexors, while the outputs may be presented through demultiplexors. Thus, a greater number of inputs and outputs may be connected to the timeswitch than can be simultaneously interconnected by the timeswitch. This is useful in applications where a large number of inputs and outputs must be served, but only a few connections are actually in use at any given time. Such a configuration is referred to as a “blocking” configuration, since new input-output connections will be blocked once the timeswitch is fully occupied.

Problems arise when the TDM voice and/or data system must grow in size to accommodate greater amounts of data and/or voice traffic. Assume, for example, that a timeswitch with a capacity of C connections includes a specific number of interfaces, appropriately chosen for the initial, smaller TDM voice and/or data system. The timeswitch may or may not be blocking, as appropriate for the intended application. In order to accommodate greater amounts of data and/or voice traffic within the system, the system size may be expanded by using some fraction F of the timeswitch capacity and interfaces to connect to a second timeswitch. Note that F must be less than ½ in order to obtain a net increase in system size; if not, there would be more connections carried between the two timeswitches than could actually be presented to the timeswitches. Such a scaling arrangement is inherently blocking, since [(1−F)*C] connections cannot be simultaneously carried over [F*C] connections if F<½.

The system size may be expanded further by adding more timeswitches, with an increasing amount of the capacity of each timeswitch used to connect to the additional timeswitches. Unfortunately, this scaling approach has several disadvantages. In addition to being expensive, each additional timeswitch provides less and less overall system size increase, thus reducing the effectiveness of the scaling. Also, assuming the scaled system includes N timeswitches fully interconnected in a mesh arrangement, then each of the N timeswitches will need N-1 interfaces to reach all of the other timeswitches in the system.

In order to reduce the number of timeswitch interconnections in the system as well as the amount of capacity used on each timeswitch, a dedicated timeswitch can be used specifically to interconnect some or all of the other timeswitches. This succeeds in reducing the number of timeswitches in the system and the related cost, but unfortunately increases the amount of connection blocking. The interconnecting timeswitch still needs as many interfaces as there are other timeswitches in the system.

Another solution is to provide the system with bigger timeswitches and bigger communication links, such that each timeswitch can support a greater number of connections. However, this burdens smaller TDM voice and/or data systems with a greater capacity, and thus associated cost, than actually required. Using larger timeswitches and communication links within the system will not prevent the system from eventually reaching a maximum data capacity. It will simply occur when the system is larger.

Accordingly, there is a need in the industry to develop a switch for use in data and/or voice systems connected to a packet network that is scalable to accommodate greater amounts of data and/or voice traffic.

### SUMMARY OF THE INVENTION

Under a broad aspect, the invention provides a switch for use with a packet network. The switch receives first packets including a source address from at least one communication interface. The switch includes a shuffling unit operative to extract data from the first packets and to generate second packets at least partly on a basis of the source address of the first packets, where the second packets are released to the packet network. The switch also includes a switching unit for receiving third packets from the packet network, the switching unit being operative to perform switching on the third packets for establishing at least one communication session.

The packet network interconnects the switch with a plurality of remote switches, where each of the remote switches includes a shuffling unit and a switching unit as described above. The shuffling finite of the switch releases each of the second packets to the packet network for routing to the switching unit of one of the remote switches, where the corresponding communication session is to be established. Accordingly, the third packets received by the switching unit of the switch include second packets sent over the packet network by the shuffling unit of at least one of the remote switches.

Advantageously, a switch in accordance with the present invention can be scaled incrementally to accommodate a greater number of packets due to increased traffic, and can spread its bandwidth out over multiple communication links.

In the present specification, a packet is a unit of information that is transmitted as whole through the network, and that may contain data and/or voice signals. If the signals are digitized, the packet can have an arbitrary number of bits. Optionally, the packet can have a defined structure, having several fields, the information in each field having a particular meaning. In a particular example, a packet includes a source address field, a destination address field and a payload field formed of at least one data segment, the latter containing the data and/or voice signal(s).

In the present specification, the expression “communication session” encompasses a broad category of services directed in general to the exchange, delivery or retrieval of audio information, video information, text-based message information, among others. Examples of such a communication session include a telephone call between two parties, a voice and/or video conference call between multiple parties, a page broadcast, etc.

In the present specification, the expression “packet network” encompasses a broad category of connectionless or connection-based networks over which packets may be routed based on the destination address contained within each packet. The packet network is not limited to any particular configuration, topology or spatial distance.

In a specific non-limiting example of implementation, a synchronous data and voice communications system for establishing communication sessions includes a packet network, a plurality of communication interfaces and a plurality of switches. Each communication interface is associated with at least one communication link that supports communication sessions between one or several sources and one or several destinations. Each switch includes a shuffling unit and a switching unit, the packed network acting as a switching core and providing for the exchange of packets between the communication interfaces, the shuffling units and the switching units. The packet network may also be used for transporting generic data generated within the system, including messages to control the various communication interfaces and functional units within the system.

Each communication interface generates first packets on a basis of the voice and/or data signals received over the respective communication link(s), and transmits the first packets over the packet network to a switch, specifically to the shuffling unit of the switch.

The shuffling unit of each switch receives first packets and is operative to extract and shuffle the data contained in these first packets for generating second packets. The shuffling unit includes a routing table that maps first packets to one or more destination addresses, at least partly on a basis of the source address of the first packets, and is operative to consult this routing table for generating the second packets.

The shuffling unit will release the second packets to the packet network, for routing to a switching unit where the corresponding communication session will be established. The shuffling unit of a particular switch may send second packets to the switching unit of the same particular switch, or to a switching unit of any one of the other switches within the communications system, in dependence of the information contained within the routing table. Note that, if the shuffling unit is sending second packets to the switching unit of the same particular switch, the second packets will preferably be routed within the particular switch, and not over the packet network.

The switching unit of each switch receives third packets from the packet network, where these third packets include second packets generated by the shuffling unit of at least one of the switches within the communications system. The switching unit includes a connection table that maps each data segment of each third packet to at least one other data segment of a third packet. On the basis of this connection table, the switching unit is operative to perform switching of the third packets for establishing connections, and thus communication sessions.

Within the communications system, the shuffling and switching units of each switch, as well as the communication interfaces, share a common time synchronization. In a specific example, this common time synchronization is related to a sampling frequency in use by the analog interfaces of the system or to the sampling frequency of an external synchronous digital network. The transfer of packets over the packet network is timed to occur between synchronization events, in order to ensure that the shuffling and switching units of the switches do not miss or repeat data in a connection they are providing due to packets being either early or delayed.

The communication interfaces, shuffling units and switching units may be implemented in software on any suitable computing platform that includes a central processing unit (CPU) that executes software or, alternatively, in hardware, firmware or a combination of software, hardware and firmware.

The data and voice communications system includes a controller for monitoring and controlling all of the connections that take place within the system. In this non-limiting example of implementation, the controller manages the routing and connection tables of each shuffling unit and switching unit within the system, in particular by dynamically updating the information contained within the routing and connection tables to reflect the current connections within the system. Such a controller may be implemented in software, hardware, firmware or a combination of all three, at a central node or distributed between various, cooperative nodes within the system.

Under another broad aspect, the invention provides a device for establishing communication sessions in a communications system including a packet network, the device comprising a shuffler and a switch. The shuffler receives first packets including a source address from at least one communication interface and is operative to shuffle the data contained within these first packets for generating second packets that are released to the packet network. The switch receives third packets from the packet network and is operative to perform switching of these third packets for establishing at least one communication session.

The present invention is further directed to a machine readable storage medium containing a program element for execution by a computing apparatus to implement a switch for establishing communication sessions in a voice and/or data communications system.

Under yet another broad aspect, the invention provides a method for establishing communication sessions in a communications system including a packet network.

### BRIEF DESCRIPTION OF THE DRAWINGS

A detailed description of examples of implementation of the present invention is provided hereinbelow with reference to the following drawings, in which:

FIG. 1 is a schematical view of a voice and data communications system for establishing communication of the present invention;

FIG. 2 illustrates the structure of a data packet;

FIG. 3 is a block diagram of a switch, as shown in FIG. 1;

FIG. 4 is a structural diagram of a computing device forming a suitable platform for the software implementation of the switch shown in FIG. 3, in accordance with an example of implementation of the invention;

FIG. 5 is a specific example of how communication sessions are established in the communications system shown in FIG. 1, in accordance with an example of implementation of the invention.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

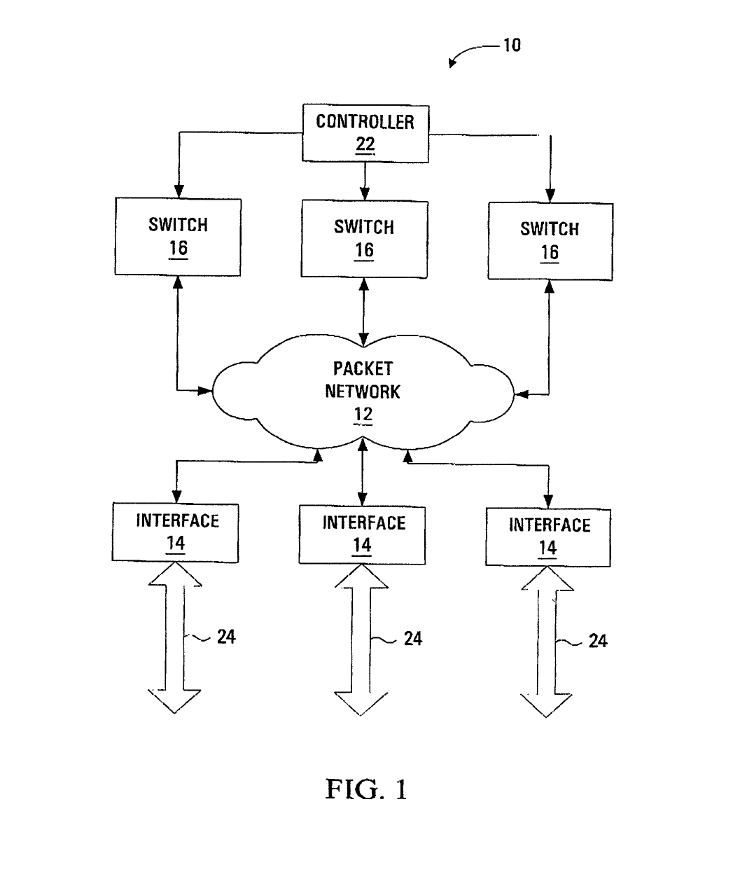

FIG. 1 illustrates a synchronous data and voice communications system 10 for establishing communication sessions, where these communication sessions may include telephone calls between two or more parties, video and/or voice conferences between two or more parties and page broadcasts, among other examples. The data flow within the communications system 10 consists of packets, where these packets may carry voice signals, data signals or a combination of both.

The communications system 10 includes a packet network 12 that provides a switching core over which packets can be exchanged between the various components of the system 10. The packet network 12 may also be used for transporting generic data generated within the communications system 10, including messages to control the various functional units of the system 10. In a specific example, the packet network 12 is an Ethernet switch. Since the concept of a packet network is well known to those skilled in the art, details concerning the implementation and functionality of such a packet network will not be described in further detail.

The communications system 10 also includes multiple communication interfaces 14 and switches 16. Each communication interface 14 is connected with a respective communication link 24 and may comprise a plurality of ports, each port being associated with a particular channel of the communication link 24. Note that a communication interface 14 may be connected to several different communication links 24. The communication interfaces 14 are operative to receive data and/or voice signals over their respective communication links 24, and to convert these signals into packets for transmission over the packet network 12. Hereinafter, the packets generated by the interfaces and transmitted over the packet network 12 will be referred to as first packets. It is not deemed necessary to discuss the standard conversion and transmission operation of the interfaces in more detail, as it is well known to those skilled in the art and is not critical to the success of the invention.

Note that each communication link 24 is characterized by a certain maximum bandwidth capacity. This maximum bandwidth capacity limits the number of communication sessions (connections) between one or several sources and one or several destinations that the communication link 24 can carry.

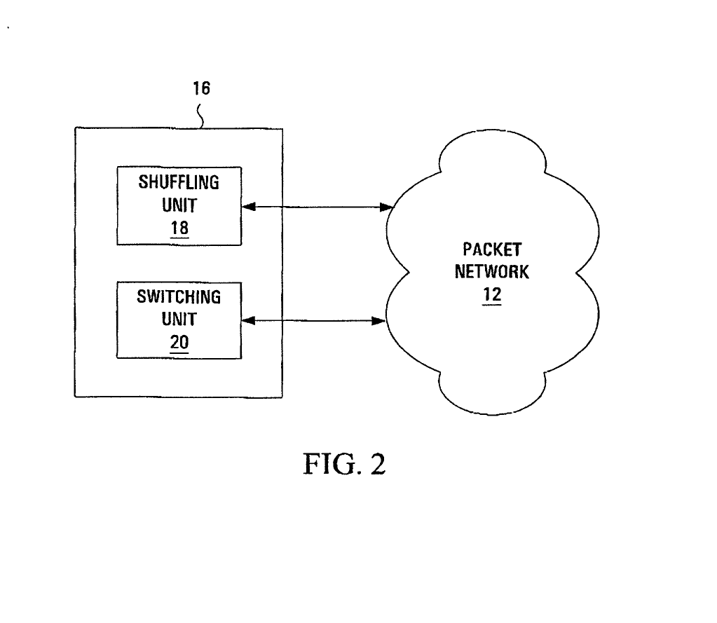

Each switch 16 includes a shuffling unit 18 and a switching unit 20, as shown in FIG. 2, where each of the shuffling unit 18 find the switching unit 20 is in data communication with the packet network 12. Thus, both units 18, 20 are capable to send/receive packets to/from other components of the communications system 10, via the packet network 12. Each shuffling unit 18 and switching unit 20 is capable to store incoming or outgoing packets, in this example in a buffer, until such a time where the shuffling or switching unit is ready to operate on these packets.

The data and voice communications system 10 also includes a controller 22, for monitoring and controlling all of the connections that take place within the communications system 10, as will be described in further detail below. Such a controller 22 is well known to those skilled in the art of communications systems for establishing communication sessions, and will not be described in great detail as it is not critical to the success of the present invention.

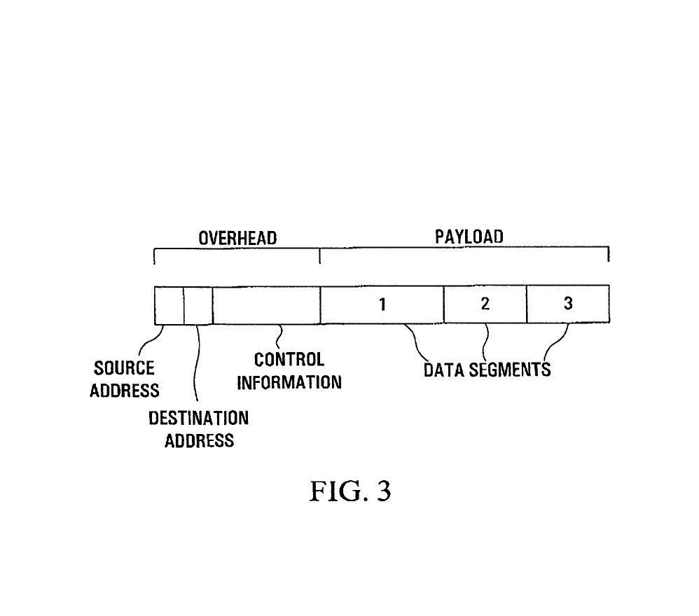

FIG. 3 illustrates the structure of a packet, according to the present example of implementation. The packet includes an overhead portion and a payload portion. The overhead portion carries address information relative to routing of the packet through the packet network 12, particularly a source address indicative of the source of the packet and a destination address indicative of the destination of the packet, as well as control information. The payload portion carries the voice and/or data signals. In a specific example, the source address is the address of a communication interface 14, while the destination address is the address of a shuffling unit 18. The payload portion is divided into one or more data segments, data segments 1 to 3 being shown in the example of FIG. 3, where each data segment carries a separate voice or data signal. It is to be understood that this packet structure is only an example and that many other ways to organize the information in the packet can be envisaged without departing from the spirit of the invention.

Within the communications system 10, the shuffling units 18, switching units 20 and communication interfaces 14 share a common time synchronization. In a specific example, this common time synchronization is related to a sampling frequency in use by the analog interfaces of the system 10 or to the sampling frequency of an external synchronous digital network. The transfer of packets over the packet network 12 is timed to occur between synchronization events, in order to ensure that the shuffling and switching units 18, 20 of the switches 16 do not miss or repeat data in a connection they are providing due to packets being either early or delayed.

For a particular switch 16, the shuffling unit 18 receives first packets from the packet network 12 and stores these first packets until a predetermined condition is met. When the predetermined condition is met, the shuffling unit 18 is operative to extract the source address from the overhead portion and the data segment(s) from the payload portion of each stored first packet. The shuffling unit 18 includes a data structure that implements a routing table, for mapping the data segments of each first packet received at the shuffling unit 18 to one or more destination addresses. On the basis of the information contained within this routing table, the shuffling unit 18 shuffles the data extracted from the first packets and generates outgoing packets, hereinafter referred to as second packets.

In a specific example, the predetermined condition to be met is the occurrence of a synchronization event. Alternatively, the predetermined condition could be the expiration of a timer set to track a fixed time interval, where this timer is reset upon generation or transmission of second packets by the shuffling unit 18. In another alternative, the predetermined condition could be the receipt of an external control signal front the controller 22. It is to be understood that many other ways to implement the predetermined condition can be envisaged without departing from the spirit of the invention.

In this non-limiting example of implementation, the data segments of each incoming/outgoing first/second packet, are indexed within the routing table on a basis of both the source/destination address of the first/second packet and a data segment identifier. In a specific example, the data segment identifier is an offset value indicative of the offset of the data segment within the payload portion of the packet, where an offset value of ‘1’ would indicate the first data segment of the payload portion following the overhead portion, ‘2’ would indicate the second data segment of the payload portion, etc.

Once the predetermined condition has been met, the shuffling unit 18 consults the routing table and, for each destination address contained in the routing table, generates a second data packet to be transmitted to the respective destination address. A second data packet destined for a particular destination address is generated with all of the first packet data segments that are mapped to this particular destination address in the routing table. The shuffling unit 18 extracts the first packet data segments required to generate a new second data packet from the storage buffer, on a basis of the source address and offset position of the first packet data segments. The shuffling unit 18 shuffles these first packet data segments into the appropriate offset position of the new second data packet, in accordance with the mappings contained in the routing table.

The shuffling unit 18 releases the second packets to the packet network 12 for transmission to the switching unit 20 of one of the switches 16, where switching of the second packets is to be performed for establishing the corresponding communication sessions.

Note that the shuffling unit 18 of a particular switch 16 may send second packets to the switching unit 20 of the same particular switch 16, or to a switching unit 20 of any one of the other switches 16 within the communications system 10, in dependence of the information contained within the routing table.

The switching unit 20 of each switch 16 receives packets from the packet network 12, hereinafter referred to as third packets, and stores these third packets until a predetermined condition is met, where this predetermined condition may be any one of the examples listed above for the shuffling unit 18. In this particular example of implementation, these third packets are in fact the second packets generated by the shuffling unit 18 of at least one of the switches 16 within the communications system 10. When the predetermined condition is met, the switching unit 20 is operative to perform a switching operation on the third packets received from the packet network 12, for establishing connections and thus communication sessions.

The switching unit 20 includes a data structure implementing a connection table that maps the data segment(s) of each third packet received at the switching unit 20 to at least one other data segment of a third packet received at the switching unit 20. On the basis of the information contained within this connection table, the switching unit 20 is operative to process the third packets for establishing communication sessions.

This processing of the third packets consists of switching the data segments of the third packets, on a basis of the connections shown in the connection table, such that the proper connections are made, and thus the communication sessions are established. Similar to the indexing scheme used in the routing table of the shuffling unit 18, in this example of implementation the data segments of each third packet are indexed within the connection table on a basis of both the source address of the third packet and a data segment identifier.

When switching the data segments of third packets for establishing a communication session, the switching unit 20 is operative to extract the data segments to be switched from the third packet payload portions, on a basis of the information contained in the connection table. The switching unit 20 next generates new packets with these extracted data segments, hereinafter referred to as fourth packets, in which the switched data segments are sent back to the appropriate sources. The switching operation performed by the switching unit 20 will be better understood from the specific example given below.

The switching unit 20 releases the fourth packets to the packet network 12 for transmission to the shuffling unit 18 of one of the switches 16, where the data contained in the fourth packets is to be shuffled and routed to the appropriate communication link.

The shuffling unit 18 receives the fourth packets from the packet network 12 and, for each fourth packet, is operative to extract the source address from the overhead portion and the data segment(s) from the payload portion. On a basis of the information contained within the above-described routing table, the shuffling unit 18 is operative to reverse map the extracted data segments of the fourth packets, whereby the extracted data segments of the fourth packets are shuffled and new outgoing packets, hereinafter referred to as fifth packets, are generated. The shuffling unit 18 releases these fifth packets to the packet network 12, for transmission to the interface 14 of a communication link 18.

In this non-limiting example of implementation, the controller 22 manages the routing and connection tables of each shuffling unit 18 and connection unit 20 within the system 10, in particular by dynamically updating the information contained within the connection tables to reflect the current connections within the system 10. The controller 22 may be implemented at a central node or distributed between various cooperative nodes, within the communications system 10. In the example shown in FIG. 1, the controller 22 is in direct communication with each of the switches 16, specifically with each shuffling unit 18 and connection unit 20. Alternatively, the controller 22 could send the routing and connection table update information for each shuffling unit 18 and connection unit 20 over the packet network 12.

Advantageously, the packet network 12 allows flexible interconnection of the various components of the communications system 10. Each component may have a single interface to the packet network 10 and still be able to send and receive packets from any other component in the communications system 10. Thus, the communications system 10 may be easily scaled by adding components (such as switches 16, shuffling units 18 and switching units 20) without disturbing existing connections. The packet network 10 is designed to scale in size and capacity, allowing a large number of components to be interconnected. The ability of the shuffling units 18 to consolidate packets from multiple communication interfaces 14 and distribute packets among multiple switching units 20 prevents the communications system 10 from being limited by the capacity of a particular interface or processing unit.

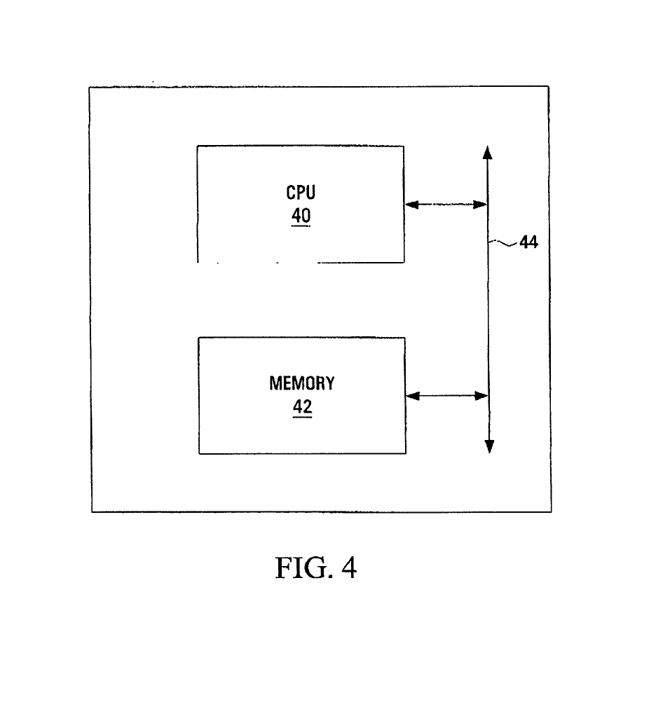

Note that each of the controller 22, interfaces 14, switches 16, shuffling units 18 and switching units 20 may be implemented in software on any suitable computing platform that includes a central processing unit (CPU) that executes software or, alternatively, in hardware, firmware or a combination of software, hardware and firmware. The basic structure of a computing device forming a suitable platform for the software implementation of the components of the communications system 10 is depicted in FIG. 4. The computing device has a Central Processing Unit (CPU) 40, a memory 42 and a bus connecting the CPU 40 to the memory 42. The memory 42 holds program instructions for execution by the CPU 40 to implement the functionality of the component.

In a specific example, a switch 16, including both the shuffling unit 18 and the switching unit 20, is implemented on a single computing platform, by a single processor. Alternatively, the shuffling unit 18 and switching unit 20 of a switch 16 are each implemented by a distinct processor.

Note that when the shuffling unit 18 and switching unit 20 of a switch are both implemented on a single computing platform, packets sent between the two units may be routed within the single computing platform, as opposed to over the packet network.

In another specific example, the switching units 20 of the switches 16 are time-division multiplexing (TDM) switches, operative to combine data segments by assigning to each data segment a different time slot in a set of time slots. Such a TDM switch repeatedly transmits a fixed sequence of time slots over a single transmission channel. Since the functionality and possible implementations of a TDM switch are well known to those skilled in the art, they will not be discussed in further detail.

In yet another specific example, each shuffling unit 18 and switching unit 20 within the system 10 is implemented by a timeswitch. Since both the shuffling unit 18 and the switching unit 20 of a switch 16 are effecting a timeswitching functionality, both units could be implemented by a single timeswitch. The shuffling and switching functions would be effected by the timeswitch at different times, between the system synchronization events, the shuffling function on a basis of the routing table(s) and the switching function on a basis of the connection table(s).

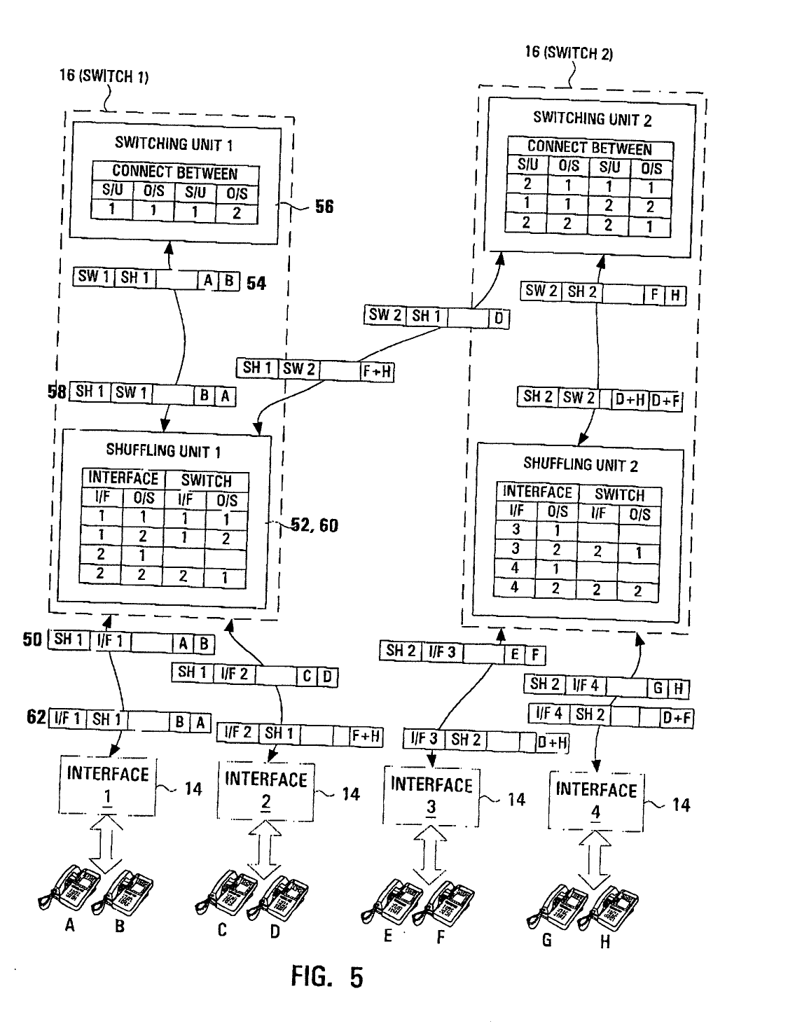

FIG. 5 depicts a specific example of how communication sessions are established within the communications system 10, in accordance with the present invention. The example involves four interfaces 14 (referred to as interfaces 1-4) and two switches 16 (referred to as switches 1-2). The channels for telephones A and B are presented at the interface 1, the channels for telephones C and D at the interface 2, the channels for telephones E and F at the interface 3 and the channels for telephones G and H at the interface 4. The communication sessions being established are: a telephone call between A and B and a conference call between D, F and H.

Note that, in FIG. 5, double headed arrows illustrate the flow of packets through the packet network 12, which itself is not shown in order to simplify and clarify the drawing.

At step 50, a packet carrying the voice signals from telephones A and B is sent from interface 1 to the shuffling unit 1. Note that the voice signal(s) from telephone A are carried in the first data segment of the payload portion of the packet (offset=1) and the voice signal(s) from telephone B are carried in the second data segment of the payload portion of the packet (offset=2). At step 52, assuming that the predetermined condition for operating on packets received from the interfaces 1 and 2 has been met, the shuffling unit 1 consults its routing table. On a basis of the mapping information contained in the routing table, the shuffling unit 1 generates a new packet for transmission to the switching unit 1, where this new packet contains the data segments of the packet received from interface 1. This new packet is sent to the switching unit 1 at step 54.

At step 56, the switching unit 1 consults its connection table and determines that the first and second data segments of the packet received from the shuffling unit 1 are to be connected together. Accordingly, the switching unit 1 generates a new packet, in which the offset positions of the first and second data segments in the payload portion have been switched. Specifically, the first data segment of the packet received from the shuffling unit 1 is located at offset=2 in the new packet and the second data segment at offset=1. This new packet is sent back to the shuffling unit 1 at step 58.

At stop 60, the shuffling unit 1 consults the routing table and, on a basis of the information contained therein, generates a new packet for transmission to the interface 1. The shuffling unit 1 performs a reverse mapping operation in order to determine which data segments of the packets received from the switching units 1 and 2 are to be shuffled into the new packet destined for interface 1. The shuffling unit 1 then shuffles the data segments into the appropriate offset position of the new packet, in accordance with the mappings contained in the routing table. In this example, the routing table shows that both data segments received from switching unit 1 are to be sent back to the interface 1. At step 62, the new packet is sent to interface 1, where the voice signal(s) from telephone B are located at offset=1 of the payload portion of the new packet, for transmission to telephone A. Similarly, the voice signal(s) from telephone A are located at offset=2 of the payload portion of the new packet, for transmission to telephone B. Thus, the call session between telephones A and B is established.

A similar packet flow is shown for establishing the conference call between telephones D, F and H. Note that certain data segments make more than one appearance in the connection table of switching unit 2, inferring a conference call where voice signal(s) from a single source are sent to at least two different destinations.

Note that, in an alternative example of implementation, a switch 16 may include only one of the shuffling unit 18 and the switching unit 20. Thus, for smaller communications systems 10 in which there are fewer connections to be made, a single switching unit 20 could provide for all of the connections being made by a plurality of shuffling units 18.

Although various embodiments have been illustrated, this was for the purpose of describing, but not limiting, the invention. Various modifications will become apparent to those skilled in the art and are within the scope of this invention, which is defined more particularly by the attached claims.

I claim:

1. A switch for use with a packet network, said switch comprising:
a) an input for receiving first packets from at least one communication link, each of said first packets including a source address;
b) a shuffling unit for processing said first packets, said shuffling unit operative to extract data from said first packets and generate second packets at least partly on a basis of the source address of said first packets, said shuffling unit releasing said second packets to the packet network;
c) a switching unit for receiving third packets from the packet network, said switching unit operative to perform switching of said third packets for establishing at least one communication session.

2. A switch as defined in claim 1, wherein each of said first, second and third packets includes a source address, a destination address and at least one data segment.

3. A switch as defined in claim 2, wherein the packet network interconnects said switch with a plurality of remote switches, said third packets including second packets generated by the shuffling units of the plurality of remote switches.

4. A switch as defined in claim 3, wherein said third packets include the second packets generated by the shuffling unit of said switch.

5. A switch as defined in claim 4, wherein said shuffling unit includes a first data structure mapping each data segment of each of said first packets to a destination address, said shuffling unit operative to consult said first data structure for generating said second packets.

6. A switch as defined in claim 5, wherein said shuffling unit generates a second packet for each destination address contained in said first data structure.

7. A switch as defined in claim 6, wherein when said shuffling unit generates a second packet having a particular destination address, said shuffling unit uses all of the first packet data segments mapped to the particular destination address in said first data structure.

8. A switch as defined in claim 7, wherein said switching unit includes a second data structure mapping each data segment of each of said third packets to at least one other data segment of said third packets, said switching unit operative to establish said at least one communication session on a basis of said second data structure.

9. A switch as defined in claim 8, wherein, upon establishing a communication session, said switching unit is operative to extract data from said third packets and generate fourth packets on a basis of said second data structure, said switching unit releasing said fourth packets to the packet network.

10. A switch as defined in claim 9, wherein said shuffling unit receives fourth packets from the packet network, said shuffling unit being operative to extract data from said fourth packets and generate fifth packets, said shuffling unit transmitting said fifth packets to at least one communication link.

11. A switch as defined in claim 10, wherein said shuffling unit includes a third data structure mapping each data segment of each of said fourth packets to a destination address, said shuffling unit operative to consult said third data structure for generating said fifth packets.

12. A switch as defined in claim 11, wherein said shuffling unit generates a fifth packet for each destination address contained in said third data structure.

13. A switch as defined in claim 12, wherein said input is a first input, said switch including a second input for receiving control information, said first, second and third data structures being dynamically updated by said control information.

14. A switch as defined in claim 12, wherein said first, second, third, fourth and fifth packets include data signals.

15. A switch as defined in claim 12, wherein said first, second, third, fourth and fifth packets include voice signals.

16. A switch as defined in claim 12, wherein said first, second, third, fourth and fifth packets include data and voice signals.

17. A switch as defined in claim 1, wherein the communication session is a telephone call between two parties.

18. A switch as defined in claim 1, wherein the communication session is a conference call between multiple parties.

19. A switch as defined in claim 1, wherein the communication session is a page broadcast.

20. A switch comprising:
a) a shuffling unit receiving first packets including a source address from at least one communication link, said shuffling unit operative to extract data from said first packets and generate second packets at least partly on a basis of the source address of said first packets, said shuffling unit transmitting each of said second packets to one of a first set of remote devices;
b) a switching unit for receiving third packets from at least one of a second set of remote devices, said switching unit operative to perform switching of said third packets for establishing at least one communication session.

21. A switch as defined in claim 20, wherein said first set of remote devices includes said switching unit.

22. A switch as defined in claim 21, wherein said second set of remote devices includes said shuffling unit.

23. A switch as defined in claim 22, wherein said first set of remote devices includes the switching units of a set of remote switches.

24. A switch as defined in claim 23, wherein said second set of remote devices includes the shuffling units of the set of remote switches.

25. A switch as defined in claim 20, wherein said first, second and third packets include data signals.

26. A switch as defined in claim 20, wherein said first, second and third packets include voice signals.

27. A switch at defined in claim 20, wherein said first, second and third packets include data and voice signals.

28. A switch as defined in claim 20, wherein the communication session is a telephone call between two parties.

29. A switch as defined in claim 20, wherein the communication session is a conference call between multiple parties.

30. A switch as defined in claim 20, wherein the communication session is a page broadcast.

31. A device for establishing communication sessions in a communications system including a packet network, said device comprising:
a) a shuffler for receiving first packets including a source address from at least one communication link, said shuffler operative to extract data from said first packets and generate second packets at least partly on a basis of the source address of said first packets, said shuffler releasing said second packets to the packet network;
b) a switch for receiving third packets from the packet network, said switch operative to perform switching of said third packets for establishing at least one communication session.

32. A device as defined in claim 31, wherein each of said first, second and third packets includes a source address, a destination address and at least one data segment.

33. A device as defined in claim 32, wherein the packet network interconnects said device with a plurality of remote devices, said third packets including second packets generated by the shufflers of the plurality of remote devices.

34. A device as defined in claim 33, wherein said third packets include the second packets generated by the shuffler of said device.

35. A device as defined in claim 34, wherein said shuffler includes a first data structure mapping each data segment of each of said first packets to a destination address, said shuffler operative to consult said first data structure for generating said second packets.

36. A device as defined in claim 35, wherein said shuffler generates a second packet for each destination address contained in said first data structure.

37. A device as defined in claim 36, wherein when said shuffler generates a second packet having a particular destination address, said shuffling unit uses all of the first packet data segments mapped to the particular destination address in said first data structure.

38. A device as defined in claim 37, wherein said switch includes a second data structure mapping each data segment of each of said third packets to at least one other data segment of said third packets, said switch operative to establish said at least one communication session on a basis of said second data structure.

39. A device as defined in claim 38, wherein, upon establishing a communication session, said switch is operative to extract data from said third packets and generate fourth packets on a basis of said second data structure, said switch releasing said fourth packets to the packet network.

40. A device as defined in claim 39, wherein said shuffler receives fourth packets from the packet network, said shuffler being operative to extract data from said fourth packets and generate fifth packets, said shuffler transmitting said fifth packets to at least one communication link.

41. A device as defined in claim 40, wherein said shuffler includes a third data structure mapping each data segment of each of said fourth packets to a destination address, said shuffler operative to consult said third data structure for generating said fifth packets.

42. A device as defined in claim 41, wherein said shuffling unit generates a fifth packet for each destination address contained in said third data structure.

43. A device as defined in claim 42, wherein said device includes an input for receiving control information, said first, second and third data structures being dynamically updated by said control information.

44. A device as defined in claim 42, wherein said first, second, third, fourth and fifth packets include data signals.

45. A device as defined in claim 42, wherein said first, second, third, fourth and fifth packets include voice signals.

46. A device as defined in claim 42, wherein said first, second, third, fourth and fifth packets include data and voice signals.

47. A device as defined in claim 31, wherein the communication session is a telephone call, between two parties.

48. A device as defined in claim 31, wherein the communication session is a conference call between multiple parties.

49. A device as defined in claim 31, wherein the communication session is a page broadcast.

50. A machine readable storage medium containing a program element for execution by a computing apparatus to implement a switch, said switch comprising:
a) an input for receiving first packets from at least one communication link, each of said first packets including a source address;
b) a shuffling unit for processing said first packets, said shuffling unit operative to extract data from said first packets and generate second packets at least partly on a basis of the source address of said first packets, said shuffling unit transmitting each of said second packets to one of a first set of remote devices;
c) a switching unit for receiving third packets from at least one of a second set of remote devices, said switching unit operative to perform switching of said third packets for establishing at least one communication session.

51. A machine-readable storage medium as defined in claim 50, wherein said first set of remote devices includes said switching unit.

52. A machine-readable storage medium as defined in claim 51, wherein said second set of remote devices includes said shuffling unit.

53. A machine-readable storage medium as defined in claim 52, wherein said first set of remote devices includes the switching units of a set of remote switches.

54. A machine-readable storage medium as defined in claim 53, wherein said second set of remote devices includes the shuffling units of the set of remote switches.

55. A method for establishing communication sessions in a communication system including a packet network, said method comprising:
a) receiving first packets including a source address from at least one communication link;
b) implementing a shuffling stage for:
i) extracting data from the first packets;
ii) shuffling the data extracted from the first packets for generating second packets at least partly on a basis of the source addresses of the first packets;
iii) releasing the second packets to the packet network;
c) implementing a switching unit for:
i) receiving third packets from the packet network;
ii) switching the third packets for establishing at least one communication session.

56. A method as defined in claim 55, wherein each of said first, second and third packets includes a source address, a destination address and at least one data segment.

57. A method as defined in claim 56, wherein said shuffling unit includes a first data structure mapping each data segment of each of said first packets to a destination address, said shuffling unit operative to consult said first data structure for generating said second packets.

58. A method as defined in claim 57, wherein said shuffling unit generates a second packet for each destination address contained in said first data structure.

59. A method as defined in claim 58, wherein when said shuffling unit generates a second packet having a particular destination address, said shuffling unit uses all of the first packet data segments mapped to the particular destination address in said first data structure.

60. A method as defined in claim 59, wherein said switching unit includes a second data structure mapping each data segment of each of said third packets to at least one other data segment of said third packets, said switching unit operative to establish said at least one communication session on a basis of said second data structure.

61. A method as defined in claim 60, further comprising the step of dynamically updating said first and second data structures.

62. A method as defined in claim 61, wherein said first, second and third packets include data signals.

63. A method as defined in claim 61, wherein said first, second and third packets include voice signals.

64. A method as defined in claim 61, wherein said first, second and third packets include data and voice signals.

65. A method as defined in claim 55, wherein the communication session is a telephone call between two parties.

66. A method as defined in claim 55, wherein the communication session is a conference call between multiple parties.

67. A method as defined in claim 55, wherein the communication session is a page broadcast.

68. A method as defined in claim 55, wherein the communication system is a data system.

69. A method as defined in claim 55, wherein the communication system is a voice system.

70. A method as defined in claim 55, wherein the communication system is a data and voice system.

71. In a communication system encompassing a plurality of switches, each switch having a shuffling unit and a switching unit:
a) the set of shuffling units being operative to:
i) receive first packets including a source address from respective communication links;
ii) extract data from the first packets for generating second packets at least partly on a basis of the source address of the first packets;
iii) transmit each of the second packets to one of the switching units of the plurality of switches;
b) the set of switching units being operative to:
i) receive third packets from at least one of the shuffling units of the plurality of switches;
ii) switch the third packets for establishing at least one communication session.

72. A communication system for establishing communication sessions, said communication system comprising:
a) a packet network;
b) a plurality of switches, each of said switches including:
i) a shuffling unit for receiving first packets including a source address from a respective communication link, said shuffling unit operative to extract data from said first packets and generate second packets at least partly on a basis of the source address of said first packets, said shuffling unit releasing said second packets to the packet network;
ii) a switching unit for receiving third packets from the packet network, said switching unit operative to perform switching of said third packets for establishing at least one communication session.

73. A communication system as defined in claim 72, wherein the switching units of said plurality of switches form a set of remote switching units and the shuffling units of said plurality of switches form a set of remote shuffling units.

74. A communication system as defined in claim 73, wherein said shuffling unit transmits said second packets over the packet network to one of the set of remote switching units.

75. A communication system as defined in claim 74, wherein said third packets are second packets sent over the packet network by at least one of the set of remote shuffling units.

76. A communication system for establishing communication sessions, said communication system comprising:
a) a packet network;
b) at least one shuffler, said shuffler receiving first packets including a source address from a respective communication link, said shuffler being operative to extract data from said first packets and generate second packets at least partly on a basis of the source address of said first packets, said shuffler transmitting said second packets to the packet network;
c) at least one switch, said switch receiving third packets from the packet network and being operative to perform switching of said third packets for establishing at least one communication session.

77. A communication system as defined in claim 76, wherein said communication system includes a plurality of shufflers and a plurality of switches, each shuffler transmitting said second packets over the packet network to one of said plurality of switches.

78. A communication system as defined in claim 77, wherein said third packets are second packets sent over the packet network by at least one of said shufflers.

79. A switch for use with a packet network, said switch comprising:
a) input means for receiving first packets from at least one communication link, each of said first packets including a source address;
b) shuffling means for processing said first packets to extract data from said first packets and generate second packets at least partly on a basis of the source address of said first packets, said shuffling means releasing said second packets to the packet network;
c) switching means for receiving third packets from the packet network, said switching means operative to perform switching of said third packets for establishing at least one communication session.

80. A switch comprising:
a) shuffling means receiving first packets including a source address from at least one communication link, said shuffling means operative to extract data from said first packets and generate second packets at least partly on a basis of the source address of said first packets, said shuffling means transmitting each of said second packets to one of a first set of remote devices;
b) switching means for receiving third packets from at least one of a second set of remote devices, said switching means operative to perform switching of said third packets for establishing at least one communication session.
